(19) United States
(12) Patent Application Publication
(10) Pub. No.: US 2021/0150200 A1
(43) Pub. Date: May 20, 2021

(54) ELECTRONIC DEVICE FOR CONVERTING HANDWRITING INPUT TO TEXT AND METHOD OF OPERATING THE SAME

(71) Applicant: Samsung Electronics Co., Ltd., Suwon-si (KR)

(72) Inventors: Dmytro ZHELEZNIAKOV, Kyiv (UA); Viktor ZAYTSEV, s. Sofievskaya Borschagovka (UA); Olga RADYVONENKO, Kyiv (UA); Pavlo TYTARCHUK, Kyiv (UA)

(21) Appl. No.: 17/037,326

(22) Filed: Sep. 29, 2020

(30) Foreign Application Priority Data
Nov. 19, 2019 (KR) 10-2019-0149109

(51) Int. Cl. G06K 9/00; G06K 9/66; G06F 40/211

(52) U.S. Cl. CPC G06K 9/00416; G06F 40/211; G06K 9/66

(57) ABSTRACT

An electronic device for converting a handwriting input to text and a method of operating the same. The method includes obtaining information about a handwriting input, recognizing at least one character corresponding to the handwriting input, obtaining a character sequence in which the at least one character is arranged in order and geometry information of the at least one character, obtaining at least one score of at least one candidate text in which the at least one character is expressed differently depending on a mathematical formula structure based on the character sequence and the geometry information, and converting the handwriting input to text including at least one character expressed in a mathematical formula structure by selecting at least one text from among the at least one candidate text based on the at least one score.

### CROSS-REFERENCE TO RELATED APPLICATION

This application is based on and claims priority under 35 U.S.C. § 119 to Korean Patent Application No. 10-2019-0149109, filed on Nov. 19, 2019, in the Korean Intellectual Property Office, the disclosure of which is incorporated by reference herein in its entirety.

### BACKGROUND

### 1. Field

The disclosure relates to an electronic device for converting a handwriting input to text and a method of operating the electronic device.

### 2. Description of Related Art

A user may perform numerical calculation and obtain graphic charts by entering formulas, such as mathematical formulas, chemical formulas, etc., into an electronic device. The entering of formulas may include keyboard/mouse based entering of formulas and handwriting recognition based entering of formulas.

For the keyboard/mouse based entering of formulas, however, the user needs to be well aware of the structure of a formula and enter the structure and content of the formula in person. For example, the user may know about specific terms or features of symbols (e.g., =, +) or structures (e.g., fractions, superscripts/subscripts, square roots) beforehand, and look for and enter a symbol or a structure contained in the formula from among a plurality of symbols or structures that may be entered into the electronic device.

On the other hand, for the handwriting recognition based entering of formulas, the user may enter a formula through direct handwriting without knowing beforehand about the features or terms of the symbols or structures contained in the formula. The user may enter a symbol or a structure by handwriting without selecting the symbol or the structure in person from among a plurality of symbols or structures, enabling the formula to be entered into the electronic device more quickly than the keyboard/mouse based entering of the formula.

Accordingly, a method of converting a handwriting input to text in the handwriting recognition based entering of formulas is required.

### SUMMARY

An objective of the disclosure is to address the aforementioned problems and provide an electronic device for converting a handwriting input to text and a method of operating the electronic device.

Another objective of the disclosure is to provide a computer-readable recording medium having recorded thereon a program to execute the method on a computer. Technical objectives of the disclosure are not limited thereto, and there may be other unstated technical objectives.

Additional aspects will be set forth in part in the description which follows and, in part, will be apparent from the description, or may be learned by practice of the presented embodiments of the disclosure.

According to an aspect of the disclosure, provided is a method, performed by an electronic device, of converting a handwriting input to text, the method including: obtaining information about a handwriting input; recognizing at least one character corresponding to the handwriting input; obtaining a character sequence in which the at least one character is arranged in order and geometry information of the at least one character; obtaining at least one score of at least one candidate text in which the at least one character is expressed differently depending on a mathematical formula structure, based on the character sequence and the geometry information; and converting the handwriting input to text including at least one character expressed in a mathematical formula structure by selecting at least one text from among the at least one candidate text based on the at least one score.

According to another aspect of the disclosure, provided is an electronic device for converting a handwriting input to text, the electronic device including: at least one processor configured to obtain information about a handwriting input, recognize at least one character corresponding to the handwriting input, obtain a character sequence in which the at least one character is arranged in order and geometry information of the at least one character, obtain at least one score of at least one candidate text in which the at least one character is expressed differently depending on a mathematical formula structure, based on the character sequence and the geometry information, and convert the handwriting input to text including at least one character expressed in a mathematical formula structure by selecting at least one text from among the at least one candidate text based on the at least one score; and a display displaying the text converted from the handwriting input.

According to another aspect of the disclosure, provided is a computer-readable recording medium having recorded thereon a program to perform the method.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example of a handwriting input, according to an embodiment of the disclosure;

FIG. 2 is a block diagram illustrating a method of converting a handwriting input to text, according to an embodiment of the disclosure;

FIG. 3 is a block diagram illustrating a text recognition process, according to an embodiment of the disclosure;

FIG. 4 is a block diagram illustrating a text generation process, according to an embodiment of the disclosure;

FIG. 5 illustrates a block diagram for describing internal configurations of an electronic device, according to an embodiment of the disclosure;

FIG. 6 illustrates a block diagram for describing internal configurations of an electronic device, according to an embodiment of the disclosure;

FIG. 7 is a flowchart illustrating a method of converting a handwriting input to text, according to an embodiment of the disclosure;

FIG. 8 illustrates an example of a Bidirectional Long Short Term Memory (BLSTM) of a Recurrent Neural Network (RNN) model, according to an embodiment of the disclosure;

FIG. 9 is a block diagram illustrating an example of training an RNN model for processing information about a stroke, according to an embodiment of the disclosure;

FIG. 10 illustrates an example of obtaining characters expressed in a mathematical formula structure from a character sequence based on a Cocke-Younger-Kasami (CYK) algorithm, according to an embodiment of the disclosure;

FIG. 11 illustrates an example of determining a score based on a spatial relation model, according to an embodiment of the disclosure;

FIG. 12 illustrates an example of determining spatial relations determined based on a spatial relation model, according to an embodiment of the disclosure;

FIG. 13 illustrates an example of determining a score based on a language model, according to an embodiment of the disclosure;

FIG. 14 illustrates an example of areas where other characters may be identified with respect to a character, according to an embodiment of the disclosure; and

FIG. 15 illustrates an example of areas identified for a handwriting input, according to an embodiment of the disclosure.

### DETAILED DESCRIPTION

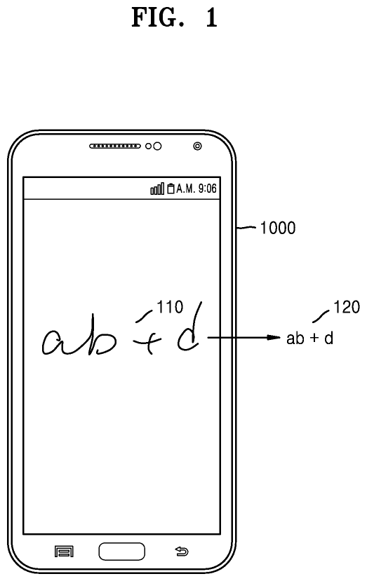

FIGS. 1 through 15, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Embodiments of the disclosure will now be described with reference to accompanying drawings to assist those of ordinary skill in the art in readily implementing them. However, the embodiments of the disclosure may be implemented in many different forms, and not limited thereto as will be discussed herein. In the drawings, parts unrelated to the description of the disclosure are omitted for clarity, and like numerals refer to like elements throughout the specification.

When A is said to “be connected” to B, it means to be “directly connected” to B or “electrically connected” to B with C located between A and C. The term “include (or including)” or “comprise (or comprising)” is inclusive or open-ended and does not exclude additional, unrecited elements or method steps, unless otherwise mentioned.

Throughout the disclosure, the expression “at least one of a, b or c” indicates only a, only b, only c, both a and b, both a and c, both b and c, all of a, b, and c, or variations thereof.

Functions related to artificial intelligence (AI) according to embodiments of the disclosure are operated through a processor and a memory. The processor may refer to one or more processors. The one or more processors may include a universal processor such as a central processing unit (CPU), an application processor (AP), a digital signal processor (DSP), etc., a dedicated graphic processor such as a graphics processing unit (GP), a vision processing unit (VPU), etc., or a dedicated AI processor such as a neural processing unit (NPU). The one or more processors may control processing of input data according to a predefined operation rule or an AI model stored in the memory. When the one or more processors are the dedicated AI processors, they may be designed in a hardware structure that is specific to dealing with a particular AI model.

The predefined operation rule or the AI model may be made by learning. Specifically, the predefined operation rule or the AI model being made by learning refers to the predefined operation rule or the AI model established to perform a desired feature (or an object) being made when a basic AI model is trained by using a learning algorithm based on a lot of training data. Such learning may be performed by a device itself in which AI is performed according to the disclosure, or by a separate server and/or system. Examples of the learning algorithm may include supervised learning, unsupervised learning, semi-supervised learning, or reinforcement learning, without being limited thereto.

The AI model may include a plurality of neural network layers. Each of the plurality of neural network layers may have a plurality of weight values, and perform neural network operation through operation between an operation result of the previous layer and the plurality of weight values. The plurality of weight values owned by the plurality of neural network layers may be optimized by learning results of the AI model. For example, the plurality of weight values may be updated to reduce or minimize a loss value or a cost value obtained by the AI model during a learning procedure. An artificial neural network may include, for example, a convolutional neural network (CNN), a deep neural network (DNN), a recurrent neural network (RNN), a restricted Boltzmann machine (RBM), a deep belief network (DBN), a bidirectional recurrent deep neural network (BRDNN), or a deep Q-network, without being limited thereto.

Throughout the specification, a handwriting input of a user may refer to an analog handwriting input of a user. The handwriting input of the user may be entered through a resistive or capacitive user interface. The handwriting input of the user may be entered using not only a finger of the user but also a writing tool such as a stylus pen.

The disclosure will now be described in detail with reference to accompanying drawings.

FIG. 1 illustrates an example of a handwriting input, according to an embodiment of the disclosure.

Referring to FIG. 1, an electronic device 1000 may display a handwriting input 110 entered by a user.

In an embodiment of the disclosure, the handwriting input 110 may be entered by the user in another method. For example, the handwriting input 110 may be entered into the electronic device 1000 by a touch input with a finger of the user or a writing tool such as a stylus pen.

In another example, a camera equipped in the electronic device 1000 may capture the handwriting input 110 and thus the handwriting input 110 included in the captured image may be entered into the electronic device 1000. For example, the electronic device 1000 may analyze the image having the handwriting input 110 to extract the handwriting input 110 from the image, and the handwriting input 110 may then be entered into the electronic device 1000. It is not limited thereto, and the user may enter the handwriting input 110 into the electronic device 1000 in other various methods.

The electronic device 1000 may be implemented in various forms. For example, the electronic device 1000 may include a digital camera, a smart phone, a laptop computer, a tablet personal computer (tablet PC), an electronic book (e-book) reader, a digital broadcasting terminal, a personal digital assistant (PDA), a portable multimedia player (PMP), a navigation system, an MP3 player, etc., without being limited thereto. In another example, the electronic device 1000 may be a wearable device that may be worn by the user. The wearable device may include at least one of accessory typed devices (e.g., watches, rings, wrist bands, ankle bands, necklaces, glasses, contact lenses), Head-Mounted Devices (HMDs), cloth or clothing typed devices (e.g., electronic clothing), body-attachable devices (e.g., skin pads), or implantable devices (e.g., implantable circuits), without being limited thereto. In the following description, for convenience of explanation, a smart phone will be taken as an example of the electronic device 1000.

In an embodiment of the disclosure, the electronic device 1000 may convert the handwriting input 110 entered by the user to text 120 and display the text 120. In an embodiment of the disclosure, the text 120 may include characters recognizable to the electronic device 1000. For example, the text 120 may include alphabets, numbers, various symbols (e.g., +, −, =, √, ∫, Σ) used in mathematical formulas, etc. It is not limited thereto, but the text 120 may include various kinds of characters, symbols, etc., which are recognizable to the electronic device 1000.

In an embodiment of the disclosure, the text 120 may include at least one character expressed in different kinds of mathematical formula structure. For example, the text 120 may include various mathematical formula structures generated with various symbols (e.g., +, −, =, √, ∫, Σ) used in mathematical formulas. For example, as for a symbol Σ, a mathematical structure (e.g., Σ_{A}^{B} C) in which at least one character may be placed on the lower side (A), the upper side (B), and the right side (C) of Σ may be generated.

Furthermore, in an embodiment of the disclosure, the electronic device 1000 may recognize not only characters but also geometry information of each character from the handwriting input 110. The electronic device 1000 may convert the handwriting input 110 to the text 120 based on the geometry information of the character. The geometry information may include, for example, information relating to the character's appearance such as the position and size of the character. In an embodiment of the disclosure, the electronic device 1000 may obtain the geometry information of each character and convert the handwriting input 110 to the text 120 based on the geometry information.

In an embodiment of the disclosure, a character may be recognized first from the handwriting input 110 and based on the recognized character, obtain the geometry information of the character. In an embodiment of the disclosure, characters included in the handwriting input 110 may be recognized, and then geometry information of each of the recognized characters may be determined.

It is not limited thereto, and the electronic device 1000 may obtain a character and geometry information of the character in various methods and convert the handwriting input 110 to the text 120.

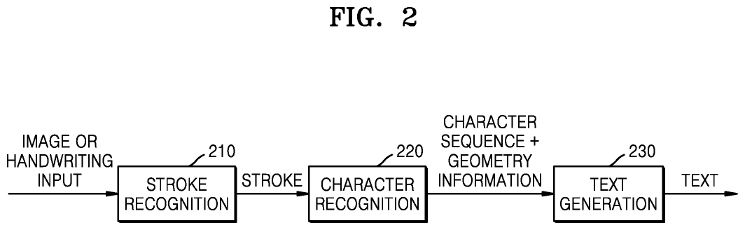

FIG. 2 is a block diagram illustrating a method of converting a handwriting input to text, according to an embodiment of the disclosure.

Referring to FIG. 2, in an embodiment of the disclosure, a handwriting input may be converted to text through a stroke recognition process 210, a character recognition process 220, and a text generation process 230. In an embodiment of the disclosure, the electronic device 1000 may recognize strokes from an input image or a handwriting input (210), recognize a character based on the recognized strokes (220), and generate text including characters expressed in a mathematical formula structure based on the recognized character (230). The electronic device 1000 may then convert the handwriting input to text and display the text.

In the stroke recognition process 210, the electronic device 1000 may identify strokes corresponding to the handwriting input included in the input image from the input image. Furthermore, when the handwriting input is entered by an input tool, the electronic device 1000 may identify strokes corresponding to the handwriting input without analyzing an image.

In an embodiment of the disclosure, the input tool may be a tool allowing the user to enter particular information into the electronic device 1000. For example, the input tool may include a finger, an electronic pen (e.g., a stylus pen), etc., but is not limited thereto.

The term ‘stroke’ may refer to a track drawn by the input tool while the input tool keeps touching the electronic device 1000 from the moment the input tool touches the electronic device 1000. For example, when for ‘3x+6y=5’, the user draws each of ‘3’, ‘x’, ‘6’, and ‘y’ at once while maintaining the touch, each of ‘3’, ‘x’, ‘6’, and ‘y’ may be a stroke. As for ‘+’, the user draws ‘−’ followed by ‘|’, so ‘−’ and ‘|’ may each be a stroke. In an embodiment of the disclosure, a stroke may make a character or a symbol, or multiple strokes may make a character or a symbol.

In an embodiment of the disclosure, in the stroke recognition process 210, the electronic device 1000 may identify a stroke in an image and obtain information about the identified stroke. For example, the electronic device 1000 may identify a stroke by determining a track drawn by the user in an image, and determine information about the identified stroke. The information about a stroke may include various types of information about the stroke, such as e.g., thickness, color, direction of the track, input order, position, etc.

In an embodiment of the disclosure, in the character recognition process 220, the electronic device 1000 may obtain a character sequence in which at least one character is sequentially arranged, based on the stroke. In an embodiment of the disclosure, the character sequence may be obtained as at least one character corresponding to at least one stroke is sequentially arranged. Furthermore, the electronic device 1000 may further obtain geometry information of each character included in the character sequence. In an embodiment of the disclosure, based on the geometry information, characters may be expressed in a mathematical formula structure.

In an embodiment of the disclosure, in the text generation process 230, the electronic device 1000 may generate text based on the character sequence and the geometry information. In an embodiment of the disclosure, the electronic device 1000 may generate text including at least one character expressed in a mathematical formula structure by obtaining scores of characters in the character sequence expressed in a mathematical formula structure based on at least one grammar model.

In an embodiment of the disclosure, the grammar model may be used in determining the scores of characters based on relations between neighboring characters, positions, sizes, etc. Based on the relations between neighboring characters, positions, sizes, etc., each character may be expressed in a mathematical formula structure. Accordingly, in an embodiment of the disclosure, based on a score value obtained based on the at least one grammar model, each character may be expressed in a mathematical formula structure.

In an embodiment of the disclosure, the electronic device 1000 may convert a handwriting input to text that includes at least one character expressed in a mathematical formula structure based on at least one grammar model.

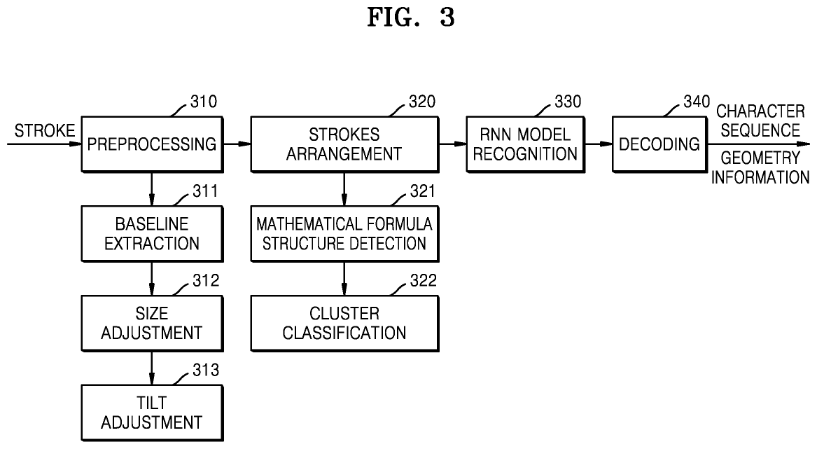

FIG. 3 is a block diagram illustrating the character recognition process 220, according to an embodiment of the disclosure.

In an embodiment of the disclosure, the character recognition process 220 of FIG. 2 may obtain a character sequence and geometry information of characters included in the character sequence from the strokes recognized in the stroke recognition process 210, through preprocessing 310, strokes arrangement 320, RNN model recognition 330, and decoding 340 processes as shown in FIG. 3.

In the character recognition process 220, the electronic device 1000 may recognize a character corresponding to a stroke. In an embodiment of the disclosure, in the character recognition process 220, the electronic device 1000 may recognize a character corresponding to a stroke by performing the preprocessing 310, the strokes arrangement 320, the RNN model recognition 330, and the decoding 340.

In the preprocessing process 310, the electronic device 1000 may perform preprocessing for recognizing a character from an identified stroke. In an embodiment of the disclosure, the preprocessing process 310 may include a baseline extraction process 311, a size adjustment process 312, and a tilt adjustment process 313.

In the baseline extraction process 311, the electronic device 1000 may generate a baseline for at least one stroke recognized in the stroke recognition process 210. In an embodiment of the disclosure, the baseline may be set as a standard for adjusting a tilt and size of the stroke. For example, the baseline may be set for each stroke, and may be set as parallel lines at the upper and lower ends of the stroke.

In the size adjustment process 312, the electronic device 1000 may adjust the size of at least one stroke based on the baseline. For example, the electronic device 1000 may adjust the size of each stroke based on the baseline so that the stroke has a certain size.

In the tilt adjustment process 313, the electronic device 1000 may adjust the tilt of at least one stroke based on the baseline. For example, the electronic device 1000 may set up an arbitrary center line of the stroke, and adjust the tilt of the stroke by turning the stroke so that the center line of the stroke and the baseline are parallel to each other.

In the strokes arrangement process 320, the electronic device 1000 may detect a mathematical formula structure (321), and based on the detected mathematical formula structure, classify at least one stroke into at least one cluster (322). In an embodiment of the disclosure, a detectable mathematical formula structure may refer to a mathematical formula structure that may be expressed as characters are placed in various positions with respect to symbols. For example, a mathematical formula structure that may be expressed with various symbols such as a fraction sign, √ (a root sign), ∫(an integral sign), Σ (a sigma sign), etc., may be detected.

In an embodiment of the disclosure, based on the detected mathematical formula structure, at least one stroke may be classified into at least one cluster. In an embodiment of the disclosure, depending on an area where at least one character may be arranged in the mathematical formula structure, the clusters may be classified. For example, when a fraction is detected as a mathematical formula structure, strokes located in a denominator area and strokes located in a numerator area may be classified into different clusters. Accordingly, based on strokes arranged in each cluster, character(s) corresponding to the strokes arranged may be recognized according to an RNN model.

In an embodiment of the disclosure, the electronic device 1000 may classify at least one stroke into clusters, and then arrange the strokes in each cluster. For example, the electronic device 1000 may arrange strokes laterally or vertically.

In the RNN model recognition process 330, the electronic device 1000 may recognize a character from the strokes arranged in each cluster using an RNN model in the strokes arrangement process 320. In the RNN model recognition process 330, the electronic device 1000 may extract features of the strokes. Furthermore, the electronic device 1000 may obtain a result of recognizing the extracted feature by sequentially entering feature information of at least one stroke corresponding to the handwriting input to the RNN model. In an embodiment of the disclosure, many different types of RNN models, such as a CNN, a long short term memory (LSTM), a bidirectional LSTM (BLSTM), etc.

In an embodiment of the disclosure, the feature information of a stroke may include various kinds of information that represent a visual feature of each stroke and may be extracted as information having a form that may be entered into the RNN model.

In an embodiment of the disclosure, as the feature information of the stroke is entered into the RNN model in the order of arrangement according to the strokes arrangement 320, the RNN model may output a result of recognizing the input feature information.

For example, as the feature information of at least one stroke corresponding to a handwriting input is sequentially entered into the RNN model, a character sequence and geometry information may be obtained.

Furthermore, in an embodiment of the disclosure, the at least one stroke may be arranged in each cluster classified depending on positions of the strokes. In an embodiment of the disclosure, the character sequence may be obtained as feature information of at least one stroke arranged in each cluster is entered into the RNN model.

In the decoding process 340, the electronic device 1000 may obtain a character sequence and geometry information based on the information output from the RNN model recognition process 330.

In an embodiment of the disclosure, information about a character that may be output by the RNN model may include information about a feature of a character corresponding to a stroke. In an embodiment of the disclosure, based on the information about the feature of the character, the electronic device 1000 may identify the character corresponding to the stroke and obtain a character sequence including the identified character. In an embodiment of the disclosure, the character sequence may include at least one character arranged in order in each cluster.

In an embodiment of the disclosure, based on the information about the feature of the character, the electronic device 1000 may further obtain a character score of the identified character. The character score may represent an extent of similarity between the information about the feature of the character and the identified character. For example, the lower the similarity between the information about the feature of the character obtained from the RNN model and the identified character, the lower character score may be determined. In an embodiment of the disclosure, the character score may be obtained for each character included in the character sequence.

In an embodiment of the disclosure, the electronic device 1000 may further obtain geometry information of each character included in the character sequence. In an embodiment of the disclosure, based on the information about the feature of each character, the electronic device 1000 may obtain geometry information including information about a position, size, shape, etc., of the character.

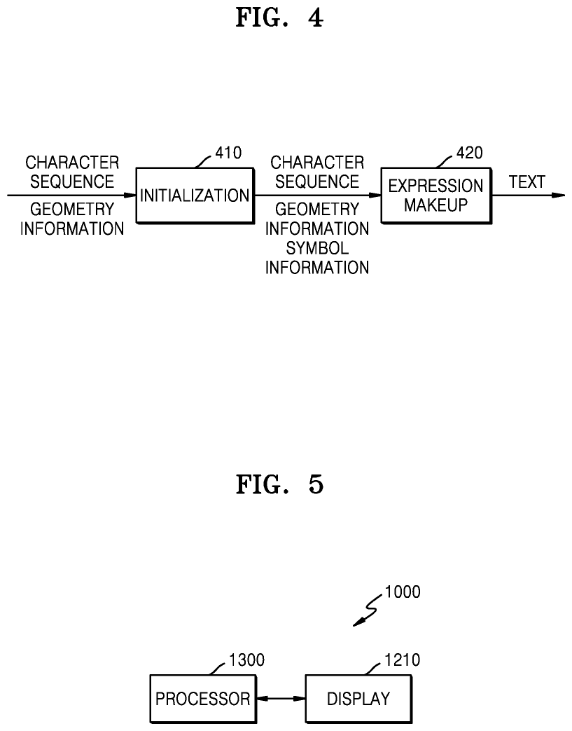

FIG. 4 is a block diagram illustrating the text generation process 230, according to an embodiment of the disclosure.

Referring to FIG. 4, in an embodiment of the disclosure, the text generation process 230 may include an initialization process 410 and an expression makeup process 420.

In the initialization process 410, the electronic device 1000 may perform preprocessing on the character sequence and geometry information output from the character recognition process 220.

In an embodiment of the disclosure, the electronic device 1000 may combine at least one character among characters included in the character sequence. For example, when parts in front of and behind a root sign are entered separately, they may be arranged in the entrance order according to the strokes arrangement and recognized as different characters. In an embodiment of the disclosure, based on position information of the recognized characters, the parts in front of and behind the root sign may be combined and recognized as a single root term.

Furthermore, in the initialization process 410, based on at least one of the character sequence or the geometry information, the electronic device 1000 may obtain symbol information that forms the mathematical formula structure. In an embodiment of the disclosure, the symbol information may include information in which a symbol related to a mathematical formula structure is identified. For example, the symbol information may include information about various types of symbols that may be used in mathematical formulas, such as a fraction sign, a root sign, an arrow, an operator, cos, tan, lim, sin, etc.

Furthermore, in an embodiment of the disclosure, the electronic device 1000 may identify a symbol among characters included in the character sequence, which may be recognized as having different meanings. For example, ‘.’ may be recognized as a period (.), or a product sign (⋅).

In an embodiment of the disclosure, information about the identified symbol may be about the aforementioned symbol, which may be used in interpreting a mathematical formula structure of a character sequence in the following expression makeup process 420.

For example, in the expression makeup process 420, when a score is determined according to a Cocke-Younger-Kasami (CYK) algorithm, operators and signs such as cos, tan, lim, sin, etc., may be handled as a character based on the symbol information.

In the expression makeup process 420, the electronic device 1000 may determine a score of at least one character expressed in a mathematical formula structure based on at least one grammar model.

In an embodiment of the disclosure, the at least one grammar model may include at least one of a spatial relation model, a probabilistic context-free grammar model (PCFG model), a language model, or a penalty model. Accordingly, in an embodiment of the disclosure, at least one score of at least one candidate text in which the at least one character is expressed differently according to the mathematical formula structure may be obtained based on at least one grammar model of the spatial relation model, the PCFG model, the language model, or the penalty model.

In an embodiment of the disclosure, the electronic device 1000 may obtain a score based on the at least one grammar model by sequentially combining at least two characters in the character sequence according to the CYK algorithm.

In an embodiment of the disclosure, a score may be obtained by at least one grammar model based on at least one of information about each character included in the character sequence, geometry information, or symbol information.

In an embodiment of the disclosure, the spatial relation model is a grammar model for determining spatial relations between at least two characters, e.g., spatial relations between left and right/upper and lower characters, superscript/subscript, etc., and determining a score of the determined spatial relation. In an embodiment of the disclosure, the electronic device 1000 may determine at least one spatial relation R between the characters based on at least one of geometry information or symbol information of at least two characters, and obtain a score of the determined spatial relation R.

In an embodiment of the disclosure, the language model is a grammar model for determining a score based on the spatial relation R of at least two characters and relationships between the characters. In an embodiment of the disclosure, based on the language model, a probability of the spatial relation R being determined by the spatial relation model for at least two characters may be determined.

For example, based on the language model, a score representing a probability of the spatial relation being built, in consideration of the order of characters, may be determined. Furthermore, based on the language model, a score representing a probability of the spatial relation being built between characters may be determined.

In an embodiment of the disclosure, according to the language model, at least one of a score representing a probability of character B appearing after character A in the spatial relation R or a score representing a probability of the spatial relation R being determined between the characters A and B may be obtained.

In an embodiment of the disclosure, the penalty model is a grammar model for compensating the score determined by another grammar model. For example, based on the penalty model, a score for compensating symbols used in a pair such as ( ) and [ ] to be expressed symmetrically to each other may be determined. In an embodiment of the disclosure, based on at least one of symbol information or geometry information, a score may be determined according to the penalty model. It is not limited thereto, but based on the penalty model, a score for compensating a character to be expressed in an appropriate structure may be determined.

In an embodiment of the disclosure, the electronic device 1000 may generate text including characters expressed in a mathematical formula structure based on a score obtained by any of various types of grammar model without being limited to the aforementioned grammar model.

FIG. 5 illustrates a block diagram for describing internal configurations of the electronic device 1000, according to an embodiment of the disclosure.

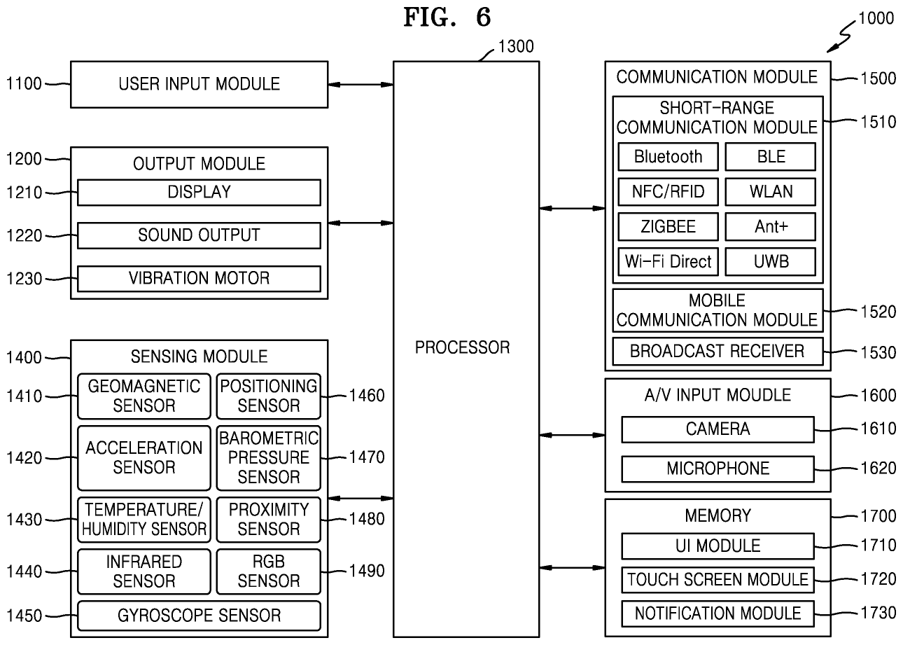

FIG. 6 illustrates a block diagram for describing internal configurations of the electronic device 1000, according to an embodiment of the disclosure.

Referring to FIG. 5, the electronic device 1000 may include a processor 1300 and a display 1210. All components shown in FIG. 5 are not, however, essential for the electronic device 1000. The electronic device 1000 may be implemented with more or fewer components than in FIG. 5.

For example, as shown in FIG. 6, the electronic device 1000 may further include a user input module 1100, an output module 1200, a sensing module 1400, a communication module 1500, an audio/video (A/V) input module 1600, and a memory 1700 in addition to the processor 1300 and the display 1210.

The user input module 1100 refers to a means that allows the user to enter data to control the electronic device 1000. For example, the user input module 1100 may include a key pad, a dome switch, a (capacitive, resistive, infrared detection type, surface acoustic wave type, integral strain gauge type, piezoelectric effect type) touch pad, a jog wheel, a jog switch, etc., without being limited thereto.

In an embodiment of the disclosure, the user input module 1100 may receive a user input to perform entering of a handwriting. For example, the user may perform entering of a handwriting on the electronic device 1000 using a writing tool.

The output module 1200 may output an audio signal, a video signal, or a vibration signal, and the output module 1200 may include the display 1210, a sound output 1220, and a vibration motor 1230.

The display 1210 displays information processed in the electronic device 1000. In an embodiment of the disclosure, the display 1210 may display a handwriting input entered by the user or an image having the handwriting input captured therein. Furthermore, in an embodiment of the disclosure, the display 1210 may display at least one text expressed in a mathematical formula structure, which is obtained as a result of converting the handwriting input.

When the display 1210 and a touch pad are implemented in a layered structure to constitute a touch screen, the display 1210 may also be used as an input device in addition to the output device. The display 1210 may include at least one of a liquid crystal display (LCD), a thin film transistor-liquid crystal display (TFT-LCD), organic light-emitting diodes (OLEDs), a flexible display, a 3D display, or an electrophoretic display. Furthermore, depending on a form of implementation of the electronic device 1000, the electronic device 1000 may include two or more displays 1210.

The sound output 1220 outputs audio data received from the communication module 1500 or stored in the memory 1700.

The vibration motor 1230 may output a vibration signal. The vibration motor 1230 may also output a vibration signal when a touch input occurs on the touch screen.

In an embodiment of the disclosure, the sound output 1220 or the vibration motor 1230 may output audio data or a vibration signal that represents at least one text obtained as a result of converting a handwriting input and expressed in a mathematical formula structure being output.

It is not limited thereto, and the text obtained as a result of converting a handwriting input may be output in various output methods.

The processor 1300 controls general operation of the electronic device 1000. For example, the processor 1300 may execute programs stored in the memory 1700 to generally control the user input module 1100, the output module 1200, the sensing module 1400, the communication module 1500, and the A/V input module 1600.

The electronic device 1000 may include at least one processor 1300. For example, the electronic device 1000 may include various types of processors such as a central processing unit (CPU), a graphics processing unit (GPU), a neural processing unit (NPU), etc.

The processor 1300 may be configured to process instructions of a computer program by performing basic arithmetic, logical, and input/output operations. The instructions may be provided from the memory 1700 to the processor 1300 or received through the communication module 1500 and provided to the processor 1300. For example, the processor 1300 may be configured to execute the instructions according to program codes stored in a recording device such as a memory.

In an embodiment of the disclosure, the processor 1300 may recognize at least one stroke of a handwriting input and recognize at least one character corresponding to the handwriting input based on the recognized stroke. Furthermore, the processor 1300 may further obtain geometry information of the recognized character. Moreover, the processor 1300 may obtain at least one score of at least one candidate text in which the at least one character is expressed differently depending on a mathematical formula structure, based on a character sequence in which the at least one characters are sequentially arranged and geometry information of each character. In addition, the processor 1300 may convert the handwriting input to text including at least one character expressed in a mathematical formula structure by selecting at least one text from among at least one candidate text based on the at least one score.

In an embodiment of the disclosure, the processor 1300 may use an RNN model to obtain a character sequence from the at least one stroke sequentially arranged. Furthermore, the processor 1300 may convert the handwriting input to text including at least one character expressed in a mathematical formula structure by obtaining the text including the at least one character expressed in the mathematical formula structure according to a score obtained based on at least one grammar model using the CKY algorithm.

The sensing module 1400 may detect a condition of or around the electronic device 1000 and forward the detected information to the processor 1300.

The sensing module 1400 may include at least one of a geomagnetic sensor 1410, an acceleration sensor 1420, a temperature/humidity sensor 1430, an infrared sensor 1440, a gyroscope sensor 1450, a positioning sensor (e.g., a global positioning system (GPS)) 1460, a barometric pressure sensor 1470, a proximity sensor 1480, or an RGB sensor (illuminance sensor) 1490, without being limited thereto.

The communication module 1500 may include at least one component that allows the electronic device 1000 to communicate with an external device. For example, the communication module 1500 may include a short-range communication module 1510, a mobile communication module 1520, and a broadcast receiver 1530.

The short-range communication module 1510 may include a Bluetooth communication module, a Bluetooth low energy (BLE) communication module, a near field communication (NFC) module, a wireless local area network (WLAN), e.g., Wi-Fi, communication module, a Zigbee communication module, an infrared data association (IrDA) communication module, a Wi-Fi direct (WFD) communication module, an ultra wideband (UWB) communication module, an Ant+ communication module, etc., without being limited thereto.

The mobile communication module 1520 transmits or receives wireless signals to and from at least one of a base station, an external terminal, or a server in a mobile communication network. The RF signal may include a voice call signal, a video call signal or different types of data involved in transmission/reception of a text/multimedia message.

The broadcast receiver 1530 receives broadcast signals and/or broadcasting-related information from the outside on a broadcasting channel. The broadcasting channel may include a satellite channel or a terrestrial channel. Depending on the implementation, the electronic device 1000 may not include the broadcast receiver 1530.

In an embodiment of the disclosure, the communication module 1500 may receive data used to convert a handwriting input to text from an external device. For example, the communication module 1500 may request the external device (e.g., a server) for at least one operation to convert the handwriting input to text, and receive a result of performing the requested operation. In an embodiment of the disclosure, the at least one operation to convert the handwriting input to text may include at least one of operations from the stroke recognition 210, the character recognition 220, or the text generation 230.

The A/V input module 1600 for inputting audio or video signals may include a camera 1610, a microphone 1620, etc. The camera 1610 may obtain image frames, such as still images or video through an image sensor in a video call mode or a photography mode. An image captured by the image sensor may be processed by the processor 1300 or an extra image processor.

In an embodiment of the disclosure, the A/V input module 1600 may generate an image in which a handwriting input is captured. The image captured by the A/V input module 1600 may be processed according to an embodiment of the disclosure into at least one text expressed in a mathematical formula structure corresponding to the handwriting input.

The microphone 1620 may process a sound signal received from the outside into electric voice data. For example, in an embodiment of the disclosure, the microphone 1620 may receive a voice signal including a command from the user to convert a handwriting input to text.

The memory 1700 may store a program for processing and control of the processor 1300, or store data input to or output from the electronic device 1000.

In an embodiment of the disclosure, the memory 1700 may store various types of data used for converting a handwriting input to text. For example, the memory 1700 may store an RNN model used for character recognition, and at least one grammar model used for generating text including at least one character expressed in a mathematical formula structure.

The memory 1700 may include at least one type of storage medium including a flash memory, a hard disk, a multimedia card micro type memory, a card type memory (e.g., SD or XD memory), a Random Access Memory (RAM), a Static Random Access Memory (SRAM), a Read-Only Memory (ROM), an Electrically Erasable Programmable Read-Only Memory (EEPROM), a Programmable Read-Only Memory (PROM), a magnetic memory, a magnetic disk, and an optical disk.

Programs stored in the memory 1700 may be classified into a plurality of modules according to the functions, e.g., a user interface (UI) module 1710, a touch screen module 1720, a notification module 1730, etc.

The UI module 1710 may provide a specified UI, a graphical user interface (GUI), etc., working with the electronic device 1000 for each application. The touch screen module 1720 may detect a touch gesture of a user over the touch screen and forward information about the touch gesture to the processor 1300. In some embodiments of the disclosure, the touch screen module 1720 may recognize and analyze a touch code. The touch screen module 1720 may include extra hardware including a controller.

Various sensors may be equipped inside or around the touch screen to detect touches or proximity touches. As an example of the sensor to detect touches on the touch screen, there may be a tactile sensor. The tactile sensor refers to a sensor that detects a contact of a particular object to such an extent that people may feel or more. The tactile sensor may detect various metrics such as roughness on a contact surface, hardness of a contacting object, the temperature on a contact point, etc.

The touch gesture of the user may include tapping, touching and holding, double tapping, dragging, panning, flicking, dragging and dropping, swiping, etc.

The notification module 1730 may generate a signal to inform occurrence of an event of the electronic device 1000.

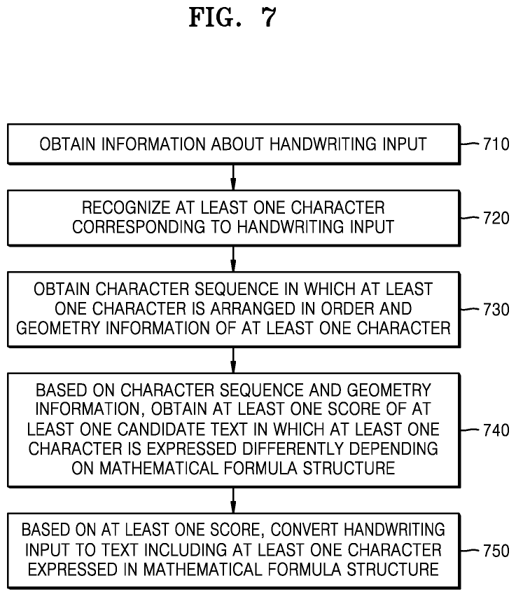

FIG. 7 is a flowchart illustrating a method of converting a handwriting input to text, according to an embodiment of the disclosure.

Referring to FIG. 7, in operation 710, the electronic device 1000 may obtain information about a handwriting input. In an embodiment of the disclosure, the electronic device 1000 may obtain information about a handwriting input in response to a touch input through a writing tool. Furthermore, the electronic device 1000 may obtain information about a handwriting input from an image in which the handwriting input is captured.

In operation 720, the electronic device 1000 may recognize at least one character corresponding to the handwriting input based on the information about the handwriting input. In an embodiment of the disclosure, the electronic device 1000 may recognize at least one stroke from the handwriting input and recognize at least one character corresponding to the handwriting input based on at least one stroke arranged in order. For example, at least one stroke may be arranged laterally or vertically in order.

In an embodiment of the disclosure, as at least one stroke is processed in order in an RNN model, at least one character corresponding to the handwriting input may be obtained. In an embodiment of the disclosure, the RNN model may sequentially process the strokes arranged in order, and as a result of recognizing the strokes, output information about at least one character corresponding to the at least one stroke.

In operation 730, the electronic device 1000 may obtain a character sequence in which the at least one character recognized in operation 720 is arranged in order, and geometry information of each character. In an embodiment of the disclosure, the geometry information may include information about a feature of appearance of the character, such as a size, a position, etc., of the character.

In operation 740, the electronic device 1000 may obtain at least one score of at least one candidate text in which the at least one character is expressed differently depending on a mathematical formula structure, based on the character sequence and the geometry information. In an embodiment of the disclosure, the score may be obtained based on at least one grammar model.

In an embodiment of the disclosure, the electronic device 1000 may sequentially combine at least one character in the character sequence according to the CYK algorithm. Furthermore, the electronic device 1000 may obtain a score of characters combined in each stage based on at least one grammar model. It is not limited thereto, but the electronic device 1000 may obtain a score of at least one character expressed in a mathematical formula structure by using various types of algorithm.

In operation 750, the electronic device 1000 may convert a handwriting input to text that includes at least one character expressed in a mathematical formula structure based on the at least one score. In an embodiment of the disclosure, the electronic device 1000 may convert the handwriting input to text including at least one character expressed in a mathematical formula structure by selecting at least one text from among at least one candidate text based on the at least one score.

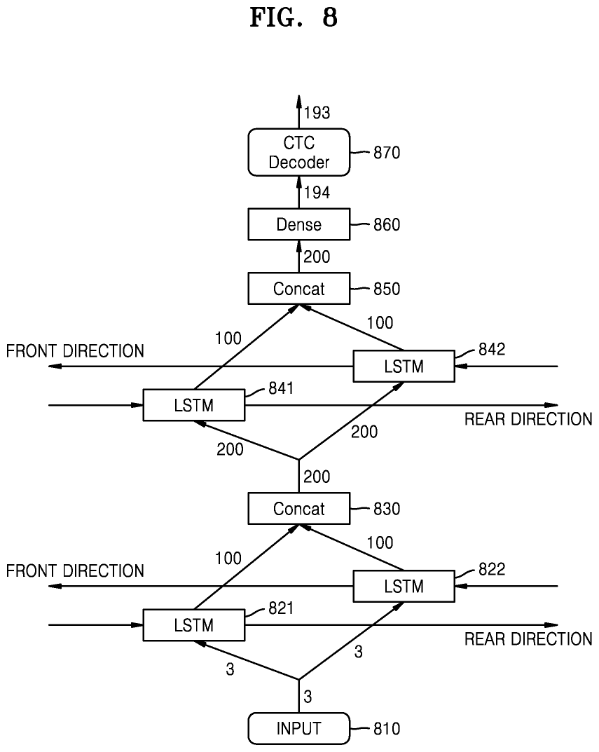

FIG. 8 illustrates an example of a BLSTM of an RNN model, according to an embodiment of the disclosure.

Referring to FIG. 8, the BLSTM may include a plurality of LSTMs 821, 822, 841, and 842, a Concat module 850, a Dense module 860, and a CTC decoder 870.

The structure of the BLSTM shown in FIG. 8 is an example, and is not limited thereto. For example, a BLSTM in any of various structures may be used.

In FIG. 8, a number written at each arrow indicates the number of pieces of information delivered along the arrow. For example, for information about a stroke, three different parameters may be entered into a BLSTM 810 and delivered to LSTMs 821 and 822.

In an embodiment of the disclosure, the information about the stroke entered into the BLSTM 810 may be entered into the front LSTM 821 and the rear LSTM 822.

In an embodiment of the disclosure, the front LSTM 821 may process information about each stroke in the order of strokes. On the other hand, in an embodiment of the disclosure, the rear LSTM 822 may process information about each stroke in the reverse order of strokes.

A Concat module 830 may combine data processed by the LSTMs 821 and 822 and deliver the combined data to the front and rear LSTMs 841 and 842. The Concat module 830 may combine the data processed by the LSTMs 831 and 822 in various methods so that the data may be entered into and processed by the front and rear LSTMs 841 and 842.

In an embodiment of the disclosure, the first LSTM 821 or 822 and the second LSTM 841 or 842 may each be a neural network model having a different structure. For example, the first LSTM 821 or 822 may be a neural network model with 41,900 weights, and the second LSTM 841 or 842 may be a neural network model with 120,700 weights. It is not limited thereto, and in an embodiment of the disclosure, the LSTMS 821, 822, 841 and 842 included in the BLSTM may be neural network models having different structures to process information of a stroke.

In an embodiment of the disclosure, data processed by the second LSTM 841 or 842 is combined by the Concat module 850, and final data may be output through the Dense module 860 and the CTC decoder 870.

In an embodiment of the disclosure, the Dense module 860 may convert the data output by the Concat module 850 into an output data format. Furthermore, the CTC decoder 870 may evaluate data output by the Dense module 860, and based on the evaluation result, perform operation of updating the BLSTM model.

It is not limited thereto, and the Dense module 860 and the CTC decoder 870 may output final data including a result of processing the input data by the BLSTM by performing various operations to output final data.

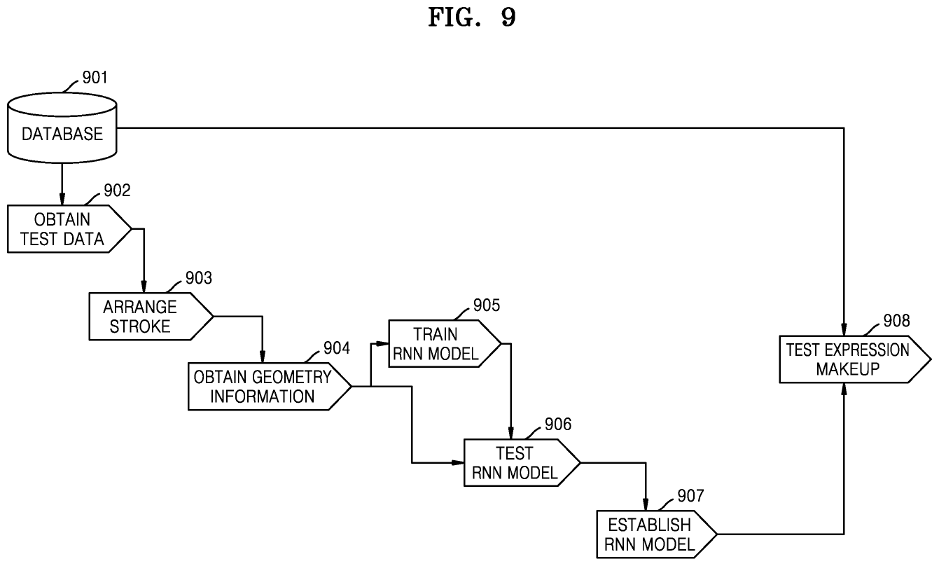

FIG. 9 is a block diagram illustrating an example of training an RNN model for processing information about a stroke, according to an embodiment of the disclosure.

Referring to FIG. 9, the electronic device 1000 may obtain test data for training of the RNN model from a database 901, in operation 902. In an embodiment of the disclosure, the test data may include an example of texts including characters expressed in different kinds of mathematical formula structures.

Furthermore, in an embodiment of the disclosure, the electronic device 1000 may classify the characters included in the test data according to mathematical formula structures, and generate a character sequence by arranging the characters in order for each cluster classified.

In operation 903, the electronic device 1000 may obtain at least one stroke corresponding to the character sequence and arrange the strokes to correspond to the character sequence. Furthermore, the electronic device 1000 may obtain information about the stroke in a form that may be entered into the RNN model, from the arranged strokes.

In operation 904, the electronic device 1000 may process the character sequence generated in operation 902 to obtain geometry information of each character.

In operation 905, the electronic device 1000 may train the RNN model based on the character sequence, geometry information and information about the strokes arranged, which are obtained in operations 902, 903, and 904. For example, the electronic device 1000 may train the RNN model to obtain the character sequence generated in operation 902 and the geometry information obtained in operation 904 from the data resulting from the RNN model processing the information about the strokes arranged. In an embodiment of the disclosure, the electronic device 1000 may train the RNN model by changing at least one weight value used in the RNN model.

In operation 906, the electronic device 1000 may test the RNN model trained in operation 905, and in operation 907, set up a final RNN model. For example, the electronic device 1000 may determine whether the character sequence generated in operation 902 and the geometry information obtained in operation 904 may be obtained from the data output as a result of entering the information about the strokes arranged into the trained RNN model, in operation 905.

In an embodiment of the disclosure, the electronic device 1000 may generate at least one character expressed in a mathematical formula structure in operation 908 based on the character sequence and the geometry information obtained according to the RNN model set up finally in operation 907. In an embodiment of the disclosure, the electronic device 1000 may update the RNN model by comparing the result of generating the at least one character expressed in the mathematical formula structure with characters expressed in the mathematical formula structure included in the database 901.

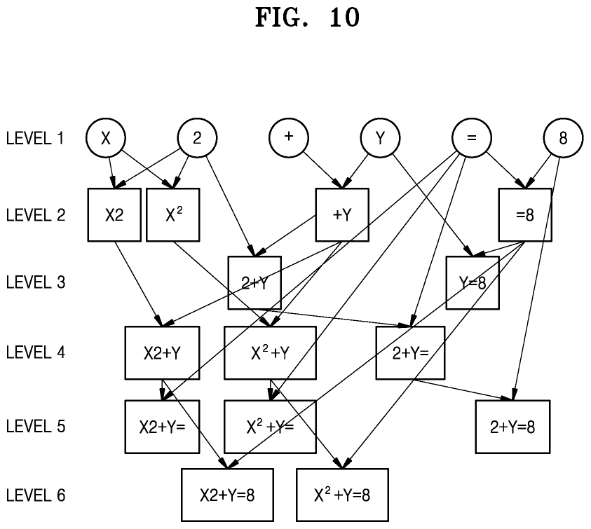

FIG. 10 illustrates an example of obtaining characters expressed in a mathematical formula structure from a character sequence based on a CYK algorithm, according to an embodiment of the disclosure.

Referring to FIG. 10, in an embodiment of the disclosure, a character sequence may include at least one character arranged in the order of X, 2, +, Y, =, and 8. In an embodiment of the disclosure, according to the CYK algorithm, at each of as many levels as the number of characters included in the character sequence, a score may be obtained, and text including at least one character expressed in a mathematical formula structure may be obtained based on the score obtained at the last level.

At level 1, a score of each of the characters X, 2, +, Y, =, and 8 included in the character sequence may be obtained. At level 1, the score that may be obtained for each character may be obtained in the following equation 1:

H_{T}=K_{C}*log(S_{C})+K_{GT}*log(S_{GT}) [Equation 1]

In equation 1, H_{T} represents a score obtained for a character, K_{C} and K_{GT} represent weight values used in obtaining the score. S_{c} represents a character score obtained based on feature information of each character obtained in the RNN model recognition process 330.

S_{GT} represents a terminal score of each character that may be determined according to a PCFG model.

In an embodiment of the disclosure, the PCFG model may be set up as in the following Table 1.

TABLE 1

| Production | | Rules | Probabilities |
|---|---|---|---|
| Binary Production | BCMP | LT BCMPR | 0.07 |
| | BCMPR | CT BEXP | 0.1 |
| | BEXP | LT BEXPR | 0.22 |
| | BEXPR | BT DT | 0.3 |
| | BEXPR | BT LT | 0.7 |
| Terminal Production | Latin | X | 0.63 |
| | Terminal (LT) | | |
| | Compare | = | 0.37 |
| | Terminal (CT) | | |
| | Latin | Y | 1.0 |
| | Terminal (LT) | | |
| | Binary | + | 0.7 |
| | Terminal (BT) | | |
| | Digital | 5 | 0.6 |
| | Terminal (DT) | | |

The PCFG model is not limited thereto, but may further include information about probabilities of other characters and symbols.

For example, in FIG. 10, S_{GT} for character ‘X’ may represent a terminal score indicating a probability of the character X being used as a Latin terminal that is a Latin character, based on the PCFG model. Furthermore, S_{GT} for character ‘8’ may represent a terminal score indicating a probability of the character 8 being used as a Digital terminal that is a number, based on the PCFG model.

At level 2, at least two of the characters processed at Level 1 may be combined to obtain a score of the combined characters represented in a mathematical formula structure. In an embodiment of the disclosure, based on the geometry information of each character, characters expressed in a mathematical formula structure may be generated.

Scores of characters combined at levels 2 to 6 may be obtained in the following equation 2:

H_{B}=K_{R}*log(S_{R})+K_{LS}*log(S_{LS})+K_{LR}*log(S_{LR})+K_{GB}*log(S_{GB})+H_{L}+H_{R}+P Equation 2

In equation 1, H_{B} represents a score obtained for combined characters, K_{R}, K_{LS}, K_{LR}, and K_{GB} represent weight values used in obtaining the score. S_{R} represents a score obtained by a spatial relation model for the combined characters. S_{LS} and S_{LR} represent a score obtained by a language model for the combined characters.

S_{GB} represents a binary score of the combined characters, which may be determined based on the PCFG model including probability values as in Table 1. For example, when of the characters in the character sequence, ‘+’ and ‘Y’ are classified into a binary terminal and a Latin terminal, respectively, in the PCFG model, for a character string having ‘+’ and ‘Y’ combined therein, S_{GB} may be determined as a probability (0.7) of the binary terminal (BT) and the Latin terminal (LT) being combined and presented.

For the character string having ‘+’ and ‘Y’ combined therein, according to the rules of Binary Production in Table 1, BT LT may be classified into BEXPR. Accordingly, at level 3, a binary score S_{GB} for a character string ‘2+Y’ with ‘2’ and ‘+Y’ combined therein may be determined as a probability of digital terminal (DT) and BEXPR being combined and presented among the rules of the binary production of the PCFG model, i.e., a probability value for the rule DT BEXPR of the binary production.

H_{L} and H_{R} refer to scores obtained for respective characters at an upper level, which are combined at the current level. For example, H_{L} and H_{R} for characters ‘X2’ of level 2 may refer to H_{T} values obtained for ‘X’ and ‘2’, respectively, at an upper level, level 1. P represents a score obtained for a character sequence based on a penalty model.

In an embodiment of the disclosure, at level a+b, characters or character strings at levels a and b are combined, and a score for the combined character string may be obtained according to equation 2.

For example, at level 3, for a character string with a character of level 1 and a character string of level 2 combined therein, a score may be obtained according to equation 2. At level 4, for a character string with a character of level 1 and a character string of level 3 combined therein or a character string with the character strings of level 2 combined together therein, a score may be obtained according to equation 2. Similarly, at levels 5 and 6, for a character string with characters or character strings of an upper level combined therein, a score may be obtained according to equation 2.

In an embodiment of the disclosure, according to a score from equation 2 obtained for each of character strings combined at the final level, level 6, candidate text corresponding to the handwriting input and including at least one character expressed in a mathematical formula structure may be determined. For example, based on a score of ‘X2+Y=8’ and a score of ‘X²+Y=8’, ‘X²+Y=8’ may be determined as text corresponding to the handwriting input.

Accordingly, in an embodiment of the disclosure, the score of the candidate text may be obtained based on the terminal score of each character in the character sequence obtained at level 1 according to the CYK algorithm and the binary score obtained based on at least one grammar model for characters combined at each level. In an embodiment of the disclosure, based on the score of the candidate text obtained based on the terminal score and the binary score, the handwriting input may be converted to text.

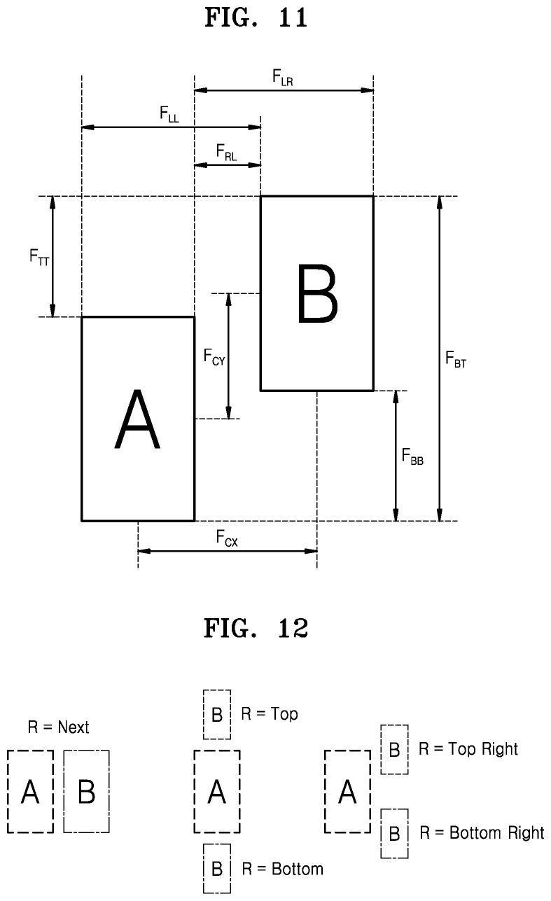

FIG. 11 illustrates an example of determining a score based on a spatial relation model, according to an embodiment of the disclosure.

Referring to FIG. 1, in an embodiment of the disclosure, for characters or character strings combined together at each level according to the CYK algorithm, a spatial relation may be determined based on a spatial relation model. In an embodiment of the disclosure, the electronic device 1000 may determine at least one of F_{LL}, F_{RL}, F_{LR}, F_{TT}, F_{CY}, F_{CX}, F_{BB}, or F_{BT} based on gaps, differences in height between characters or character strings combined together, etc., according to geometry information. In an embodiment of the disclosure, the electronic device 1000 may determine spatial relations between characters by entering the determined values into the spatial relation model.

It is not limited thereto, but the spatial relation may be determined according to various information determined based on the geometry information of the characters or character strings combined together.

FIG. 12 illustrates an example of determining spatial relations determined based on a spatial relation model, according to an embodiment of the disclosure.

In an embodiment of the disclosure, based on a spatial relation model, the electronic device 1000 may determine one of five spatial relations, Next, Top, Bottom, Top Right, and Bottom Right shown in FIG. 12 to be a spatial relation R. It is not limited thereto, but the electronic device 1000 may determine various types of spatial relations between at least two characters based on the spatial relation model.

What are shown in FIGS. 11 and 12 are examples of determining a spatial relation between two characters combined at each level, but without being limited thereto, spatial relations between two or more characters may be determined. For example, when text of ‘C²’ instead of ‘A’ is combined with ‘B’, spatial relations between C² and B may be determined. For example, when ‘B’ is located next to ‘C²’, as in ‘C²Btial relation between them may be determined as ‘Next’.

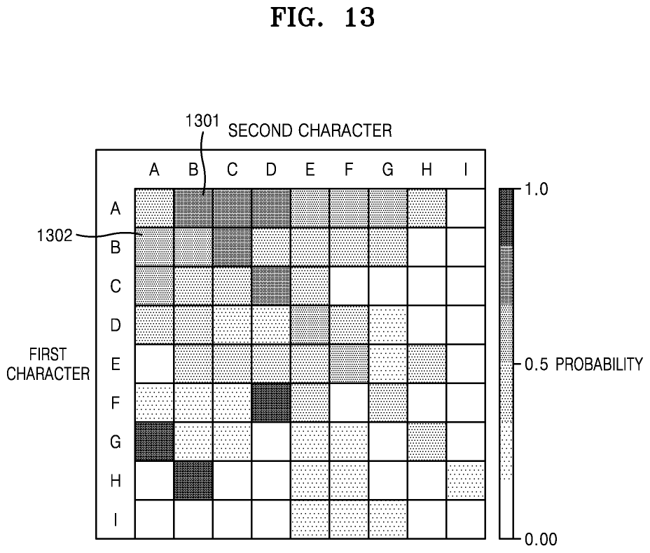

FIG. 13 illustrates an example of determining a score based on a language model, according to an embodiment of the disclosure.

In an embodiment of the disclosure, the electronic device 1000 may obtain two scores S_{LS} and S_{LR} based on a language model. In an embodiment of the disclosure, S_{LS} may be determined to be P(B|AR), a probability of the relation between A and B being set to R according to the spatial relation model of FIG. 12 when B appears after A. Furthermore, in an embodiment of the disclosure, S_{LR} may be determined to be P(R|AB), a probability of the relation between A and B being set to R according to the spatial relation model of FIG. 12.

What is shown in FIG. 13 is an example of representing probability values according to a language model, which may be determined between a first character and a second character. For example, when B appears after A, S_{LS} for the combination of AB may be determined as a probability value indicated by reference numeral 1301. S_{LR} for the combination of AB may be determined to be a value resulting from addition of probability values indicated by reference numerals 1301 and 1302.

In an embodiment of the disclosure, for characters or character strings combined at each level, a score may be obtained based on a language model. It is not limited to what is shown in FIG. 13, but in another embodiment of the disclosure, the language model may further include information about appearance probability values between two character strings. For example, the first and second characters shown in FIG. 13 may each be a character string including at least one character, and probability values of the two character strings may exist in the language model.

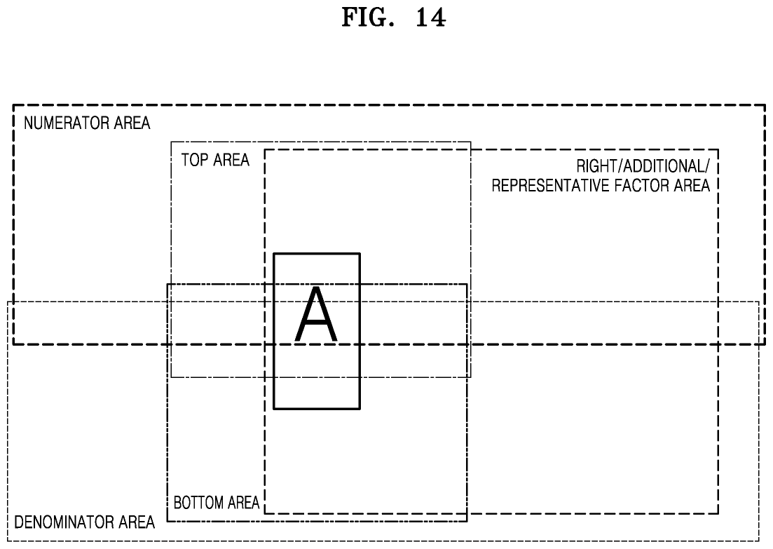

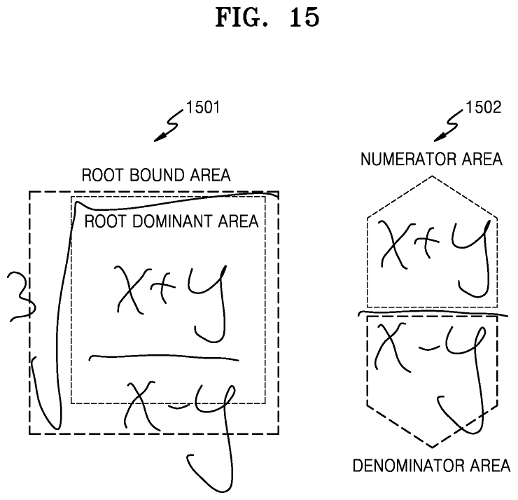

FIG. 14 illustrates an example of areas where other characters may be identified with respect to a character, according to an embodiment of the disclosure.

Referring to FIG. 14, an area with respect to character A, where another character may be identified, may be classified into a numerator area, a denominator area, a top area, a bottom area, a right/additional representative factor area, etc.

In an embodiment of the disclosure, based on geometry information of each character, an area with respect to a character, where there is another character, may be determined to be one of the aforementioned areas. In an embodiment of the disclosure, the electronic device 1000 may determine spatial relations between the plurality of characters based on the determined area.

It is not limited thereto, but the electronic device 1000 may use relative areas between a plurality of characters in determining various relational information between the plurality of characters.

Furthermore, in an embodiment of the disclosure, for each area determined with respect to a character as in FIG. 14, a cluster is classified for a stroke, and for each cluster, a character sequence may be generated. In an embodiment of the disclosure, according to the character sequence generated for each cluster, text including characters expressed in a mathematical formula structure, corresponding to each area, may be generated. Furthermore, the text generated for each area may be placed based on the corresponding area and presented as text corresponding to the handwriting input.

FIG. 15 illustrates an example of areas identified for a handwriting input, according to an embodiment of the disclosure.

Referring to 1501 of FIG. 15, based on a root sign of a handwriting input, a root bound area and a root dominant area may be identified from the handwriting input. Referring to 1502 of FIG. 15, based on a fraction sign of the handwriting input, a numerator area and a denominator area may be identified from the handwriting input.

In an embodiment of the disclosure, for each area identified, a cluster may be classified for a stroke, and for each cluster, a character sequence may be generated. In an embodiment of the disclosure, according to the character sequence generated for each cluster, text including characters expressed in a mathematical formula structure, corresponding to each area, may be generated. Furthermore, the text generated for each area may be placed based on the corresponding area and presented as text corresponding to the handwriting input.

In an embodiment of the disclosure, with a unit of character determined according to an RNN model, instead of a unit of stroke, a score is determined according to at least one grammar model, so that a handwriting input may be converted to text with less amount of computation.

Embodiments of the disclosure may be implemented in the form of a computer-readable recording medium that includes computer-executable instructions such as the program modules executed by the computer. The computer-readable recording medium may be an arbitrary available medium that may be accessed by the computer, including volatile, non-volatile, removable, and non-removable mediums. The computer-readable recording medium may also include a computer storage medium and a communication medium. The volatile, non-volatile, removable, and non-removable mediums may be implemented by an arbitrary method or technology for storage of information, such as computer-readable instructions, data structures, program modules, or other data. The communication medium may include computer-readable instructions, data structures, or program modules, and include arbitrary information delivery medium.

In the specification, the term “module” may refer to a hardware component such as a processor or a circuit, and/or a software component executed by the hardware component such as the processor.

According to an embodiment of the disclosure, with a unit of character determined according to an RNN model, instead of a unit of stroke, a score is determined according to at least one grammar model, so that a handwriting input may be converted to text with less amount of computation.

Several embodiments have been described, but a person of ordinary skill in the art will understand and appreciate that various modifications can be made without departing the scope of the disclosure. Thus, it will be apparent to those ordinary skilled in the art that the true scope of technical protection is only defined by the following claims. Thus, it will be apparent to those of ordinary skill in the art that the disclosure is not limited to the embodiments described, but can encompass not only the appended claims but the equivalents. For example, an element described in the singular form may be implemented as being distributed, and elements described in a distributed form may be implemented as being combined.

While the invention has been shown and described with reference to certain exemplary embodiments thereof, it will be understood by those skilled in the art that various changes in form and details may be made therein without departing from the spirit and scope of the invention as defined by the appended claims and their equivalents.

Although the present disclosure has been described with various embodiments, various changes and modifications may be suggested to one skilled in the art. It is intended that the present disclosure encompass such changes and modifications as fall within the scope of the appended claims.

What is claimed is:

1. A method, performed by an electronic device, of converting a handwriting input to text, the method comprising:
obtaining information about a handwriting input;
recognizing at least one character corresponding to the handwriting input;
obtaining a character sequence in which the at least one character is arranged in order and geometry information of the at least one character;
obtaining at least one score of at least one candidate text in which the at least one character is expressed differently depending on a mathematical formula structure based on the character sequence and the geometry information; and
converting the handwriting input to text including at least one character expressed in a mathematical formula structure by selecting at least one text from among the at least one candidate text based on the at least one score.

2. The method of claim 1, wherein the character sequence and the geometry information are obtained in response to feature information of at least one stroke corresponding to the handwriting input being entered into a Recurrent Neural Network (RNN) model in order.

3. The method of claim 2, wherein:
the at least one stroke is arranged for each cluster classified by a position of each stroke, and
the character sequence is obtained in response to feature information of at least one stroke arranged for each cluster being entered into the RNN model.

4. The method of claim 1, wherein the at least one score is obtained based on at least one grammar model among a spatial relation model, a probabilistic context-free grammar (PCFG) model, a language model, or a penalty model.

5. The method of claim 4, wherein:
based on the spatial relation model, a spatial relation R between at least two characters in the character sequence is determined, and
based on the language model, a probability of the spatial relation R being determined by the spatial relation model for the at least two characters is determined.

6. The method of claim 1, wherein the at least one score is obtained by sequentially combining at least two characters in the character sequence according to a Cocke-Younger-Kasami (CYK) algorithm.

7. The method of claim 6, wherein the at least one score is obtained based on a terminal score of each character in the character sequence obtained at a first level according to the CYK algorithm and a binary score obtained based on at least one grammar model for characters combined at each level.

8. An electronic device for converting a handwriting input to text, the electronic device comprising:
at least one processor configured to:
obtain information about a handwriting input,
recognize at least one character corresponding to the handwriting input,
obtain a character sequence in which the at least one character is arranged in order and geometry information of the at least one character,
obtain at least one score of at least one candidate text in which the at least one character is expressed differently depending on a mathematical formula structure based on the character sequence and the geometry information, and
convert the handwriting input to text including at least one character expressed in a mathematical formula structure by selecting at least one text from among the at least one candidate text based on the at least one score; and
a display displaying the text converted from the handwriting input.

9. The electronic device of claim 8, wherein the character sequence and the geometry information are obtained when feature information of at least one stroke corresponding to the handwriting input is entered into a Recurrent Neural Network (RNN) model in order.

10. The electronic device of claim 9, wherein:
the at least one stroke is arranged for each cluster classified by a position of each stroke, and
the character sequence is obtained when feature information of at least one stroke arranged for each cluster is entered into the RNN model.

11. The electronic device of claim 8, wherein the at least one score is obtained based on at least one grammar model among a spatial relation model, a probabilistic context-free grammar (PCFG) model, a language model, or a penalty model.

12. The electronic device of claim 11, wherein:
based on the spatial relation model, a spatial relation R between at least two characters in the character sequence is determined, and
based on the language model, a probability of the spatial relation R being determined by the spatial relation model for the at least two characters is determined.

13. The electronic device of claim 8, wherein the at least one score is obtained by sequentially combining at least two characters in the character sequence according to a Cocke-Younger-Kasami (CYK) algorithm.

14. The electronic device of claim 13, wherein the at least one score is obtained based on a terminal score of each character in the character sequence obtained at a first level according to the CYK algorithm and a binary score obtained based on at least one grammar model for characters combined at each level.

15. A non-transitory, computer-readable recording medium comprising program code that, when executed by a processor of an electronic device, causes the electronic device to:
obtain information about a handwriting input;
recognize at least one character corresponding to the handwriting input;
obtain a character sequence in which the at least one character is arranged in order and geometry information of the at least one character;
obtain at least one score of at least one candidate text in which the at least one character is expressed differently depending on a mathematical formula structure based on the character sequence and the geometry information; and
convert the handwriting input to text including at least one character expressed in a mathematical formula structure by selecting at least one text from among the at least one candidate text based on the at least one score.

16. The computer-readable recording medium of claim 15, wherein the character sequence and the geometry information are obtained when feature information of at least one stroke corresponding to the handwriting input is entered into a Recurrent Neural Network (RNN) model in order.

17. The computer-readable recording medium of claim 16, wherein:
the at least one stroke is arranged for each cluster classified by a position of each stroke, and
the character sequence is obtained when feature information of at least one stroke arranged for each cluster is entered into the RNN model.

18. The computer-readable recording medium of claim 15, wherein the at least one score is obtained based on at least one grammar model among a spatial relation model, a probabilistic context-free grammar (PCFG) model, a language model, or a penalty model.

19. The computer-readable recording medium of claim 18, wherein:
based on the spatial relation model, a spatial relation R between at least two characters in the character sequence is determined, and
based on the language model, a probability of the spatial relation R being determined by the spatial relation model for the at least two characters is determined.

20. The computer-readable recording medium of claim 15, wherein the at least one score is obtained by sequentially combining at least two characters in the character sequence according to a Cocke-Younger-Kasami (CYK) algorithm.
